(19) United States
(12) Patent Application Publication
(10) Pub. No.: US 2009/0182653 A1
(43) Pub. Date: Jul. 16, 2009

(54) SYSTEM AND METHOD FOR CASE MANAGEMENT

(75) Inventor: ELLEN ZIMILES, New York, NY (US)

Correspondence Address: DUANE MORRIS LLP - DC, 505 9th Street, Suite 1000, WASHINGTON, DC, 20004-2166, US

(73) Assignee: Daylight Forensic & Advisory LLC, New York, NY (US)

(21) Appl. No.: 12/350,161

(22) Filed: Jan. 7, 2009

Related U.S. Application Data
(60) Provisional application No. 61/006,342, filed on Jan. 7, 2008.
(60) Provisional application No. 61/136,937, filed on Oct. 15, 2008.

(51) Int. Cl. G06Q 10/00; G06F 17/30; G06N 5/02; G06Q 40/00

(52) U.S. Cl. 705/30; 707/5; 706/52

(57) ABSTRACT

A case management system and method for evaluating a plurality of transactions against a set of rules, determining which rules are satisfied, scoring the transactions as a function of the satisfied rules, and risking ranking the transactions as a function of the transaction scores.

The present application claims the priority of U.S. Provisional Application Ser. No. 61/006,342 filed Jan. 7, 2008, and U.S. Provisional Application Ser. No. 61/136,937 filed Oct. 15, 2008, the disclosures of which are hereby incorporated by reference herein.

The present application is directed to a system and method of case management. In one aspect, the present disclosure is directed to the management and analysis of transactions for use in assessing compliance with federal and international statutes and regulations.

The present disclosure uses the review and analysis of business and financial transactions as an exemplary embodiment, but the teachings of the present disclosure apply to the review and analysis of any transactions for compliance with rules and statutes including health care transactions, insurance transactions, security and mutual fund transactions, etc

Compliance with federal and international statutes and regulations regarding business and financial transactions has received increased attention in recent years, owing partially to the increase in globalization of industries, the threat of terrorism from international entities, and recent high profile accounting fraud cases. For example, enforcement of the Federal Corruption Protection ACT (FCPA) is at an all time high with the Department of Justice and the Securities and Exchange Commission bringing twice as many cases in 2007 than in 2006. This trend is expected to continue.

With respect to business and financial transactions, the surge in enforcement actions has created an unprecedented amount of information that companies are now required to maintain and analyze to ensure compliance with the myriad of international and federal laws. Prior art methods utilized to analyze and ensure compliance typically have involved manual review of business records and limited use of automated processes to broadly classify transactions that required further manual review. Such prior art methods suffered several deficiencies. First, the prior art methods lacked a standard methodology and relied mainly on subjective criteria rather than an objectively defined criteria for identifying problems. Lack of a standardized methodology makes comparative analysis across cases practically impossible. Second, the prior art does not provide a mechanism that allows for complex trend analysis across entities, rules and behaviors. Third, the prior art did not afford the opportunity to conduct comprehensive analysis of historical data. And lastly the prior art does not provided for cradle to grave life cycle case management for ensuring the proper analysis and compliance with multiple requirements.

For example, the present disclosure may be used to ensure compliance with U.S. and international anti-bribery and corruption regulations, and may be used to identify suspicious financial transactions, In another aspect, the disclosure may be used to build customized rules which may be used to identify specific transactions they may be related to activity that is not in compliance with applicable rules and regulations.

For example, one of the current problems in identifying suspicious financial transactions is the amount of analysis which must be performed. Typically, financial transactions may be evaluated using automated processes that may generate an alert. However, the amount of data that is reviewed is voluminous and the results of automated processes normally result in a large amount of data that must still be analyzed manually to distinguish between suspicious activities and false positives. Analyzing false positives created by automated systems represents a huge waste or resources and serves to mask activities that may otherwise be identified as suspicious. Prior art systems that relied on automated processes typically required writing a new software script to refine the analysis being performed. The rewriting of software scripts is a time consuming and expensive option.

By way of another example, compliance with the FCPA may require analyzing thousands of records of different types of transactions with thousands of entities located throughout the world involving thousands of third party financial institutions located throughout the world. These records may include vendor lists, disbursement journals, employee expense reports and financial records of various parties including transactions with freight forwarders, accounting and law firms, financial institutions, lobbyists, consultants, brokers and distributors. The amount of data that is reviewed is voluminous and the results of any existing automated processes normally results in a large amount of data that must still be analyzed manually to distinguish between illegal and permitted business transactions. Even if automated processes are involved, the amount of information being analyzed may require many different analysts to review the data. The involvement of many different analysts reviewing portions of the data severely impacts the ability to spot trends and relational circumstances that may be helpful in identifying compliance problems.

The present disclosure eliminates many of the problems found in prior art systems by allowing for the identification of customized patterns and characteristics based on historical data, and the subsequent application of these proprietary patterns and characteristics to identify transactions that may pose potential risks. Thus, the analysis can help identify activity that may be red-flagged for further analysis, or for which corrective or preventive action must be taken. Within the identified risks, the present disclosure provides a proprietary method of risk rating based on a scoring system which helps identify the order in which the risks must be addressed. In another embodiment trend analysis can be used to identify the most effective mitigation strategy.

In another aspect, the present disclosure eliminates many of the problems found in prior art systems by allowing for the development of customized rules which minimize false positives. For example, the present disclosure may be used to create ad hoc rules during the analysis of data, which can then be used during further analysis to identify trends or eliminate transactions which would otherwise be identified as a false positive. In one such example, customized rules can be weighted accordingly based on current reviewed activity or based on historical performance. Thus computer logic can be used to help refine analysis to result in more accurate assessments and less false positives.

In another aspect, the present disclosure may also create relationships amongst the reviewed data fields and present the results to analysts in a format which expedites further review. Relationship rules can be identified and created as a function of the specific activity that is being sought. For example, there may be a commonality of transactions which can be identified and therefore used to more efficiently manage a case.

In another aspect, the present disclosure creates new metrics for tracking the case management process. Full functionality allows grouping, sorting and filtering of present analyses. Work flow tracking against historical performance can be utilized to evaluate the current case against previous cases. Historical statistics can be collected and analyzed as a function of the activity, the analyst, the transactions, the financial institution, etc.

The present disclosure also affords full life-cycle case management by standardizing work flows and providing generation of reports with standardized results such that common treatment is provided to similarly situated cases.

### BRIEF DESCRIPTION OF THE DRAWINGS

FIG. 1 is simplified pictorial flowchart of one embodiment of the present disclosure.

FIG. 2 is a simplified pictorial representation of a user interface identifying customized rules for use with one embodiment of the present disclosure.

FIG. 3 is a simplified pictorial representation of a user interface identifying the attributes of a case in one embodiment of the present disclosure

FIG. 4A is a simplified pictorial representation of a user interface identifying the attributes of transactions in one embodiment of the present disclosure.

FIG. 4B is a simplified pictorial representation of a user interface for generating an automated report in one embodiment of the present disclosure.

FIG. 5 is a simplified pictorial representation of a user interface identifying the attributes of a rule in one embodiment of the present disclosure.

FIG. 6 is a simplified pictorial representation of a user interface identifying the attributes of transactions in a case in one embodiment of the present disclosure.

FIG. 7 is a simplified pictorial representation of work flow report produced by one embodiment of the present disclosure.

FIG. 8 is a simplified pictorial representation of a case category report produced by one embodiment of the present disclosure

### DETAILED DESCRIPTION

The present disclosure is directed at technology to identify suspicious transactional activity that may be indicative of money laundering, terrorist financing, FCPA violations, bribery or corrupt activity, healthcare or insurance fraud, or other activity that is not in compliance with applicable regulations and statutes. The present disclosure utilizes automated and manual analyses of master vendor lists, disbursements journals, employee expense reimbursement and central treasury records in an effort to flag high risk geographies, industries and other unusual or suspicious activity, transactions or payments that may be characteristic of such non-compliant activity.

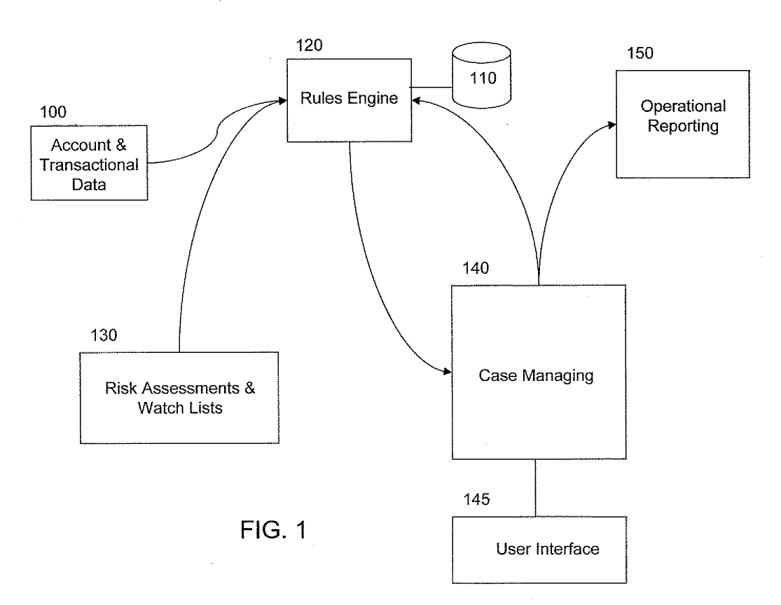

With reference to FIG. 1, one embodiment of the present disclosure is shown. Account and transactional data is provided for analyses and review 100. The data can include information that is captured to evidence a transaction and may include vendor lists, disbursement journals, employee expense reports, account transfers, accounts payable, accounts receivable, invoices, check registers, ledgers, purchase orders, claims and financial records of various parties including transactions with freight forwarders, accounting and law firms, financial institutions, lobbyists, consultants, brokers and distributors. The data can be provided electronically from the entity or may be provided through an interim medium such as tapes, DVD, CD or the like. The data is loaded into a database 110 for further analysis by rules engine 120.

Risk attributes 130 are also provided to the database 110, and may include information from third party entities and agencies, including Office of Foreign Assets Control (“OFAC”), the Government Services Administration's Excluded Parties List, the Bank of England Financial Sanctions Unit, Bureau of Industry and Security, Politically Exposed Persons List, DTC debarred parties List, World Bank listing of Ineligible Firms, UN Consolidated List, Hong Kong Monetary Authority, Terrorist Exclusion List, and the European Union Consolidated List. The risk attributes may also be provide d by customized analysis of historical data and can be derived from corporate records and directorships, criminal history queries, civil litigation history, judgments, liens and bankruptcies, and professional licensing and disciplinary records. The risk attributes can include indications of hidden relationships (i.e., vendor information matches employee information), indications of unusual payment patterns (i.e., multiple billings in short period of time, payments in round dollar amounts, sequentially numbered invoices, amount just under reportable threshold), request for unusual payment terms (i.e., checks made payable to “cash,” payment to bank in unlikely jurisdiction), indications of shell corporations (i.e., entities in off-shore locations), missing data (i.e., TIN No., phone number, etc.), known high-risk geographies, known high-risk industries (freight forwarders, lobbyists, etc), and other indicia of suspicion.

Rule engine 120 analyzes the data provided 100 against customized rules derived from the risk attributes 130 to determine alerts of activity that may require further review. The customized rules may be based on an historical analysis of patterns and characteristics that tend to identify suspicious transactions. For example, in the context of FCPA, the rules may include the identification of high risk geographies, unusual payment instructions, high risk industries and the type and frequency of use of intermediaries. Once the patterns and characteristics of known activities have been established, the rules engine 120 can thoroughly examine the provided data 100 for similar patterns and characteristics in order to adequately assess exposure and compliance with FCPA. Rules based engine 120 can be implemented on a Micorsoft.Net and SQL Server Platform.

The rules engine 120 is an object oriented engine that provides for link analysis, and temporal and geospatial data mining. The rules engine 120 works on objects, including accounts, transactions, rules and parties, and provides processed data to a user interface for review and manipulation including full interactive functionality of sorting, filtering and grouping. The rules engine links the objects to allow relationships existing in the database to be exploited.

For example, for the purpose of applying risk attributes 130 and delivering high risk items for further review, data for a vendor 100 can be stored in database 110 in order to identify activity that could be evidence of money laundering, terrorist financing, FCPA violations, bribery or other corrupt behavior.

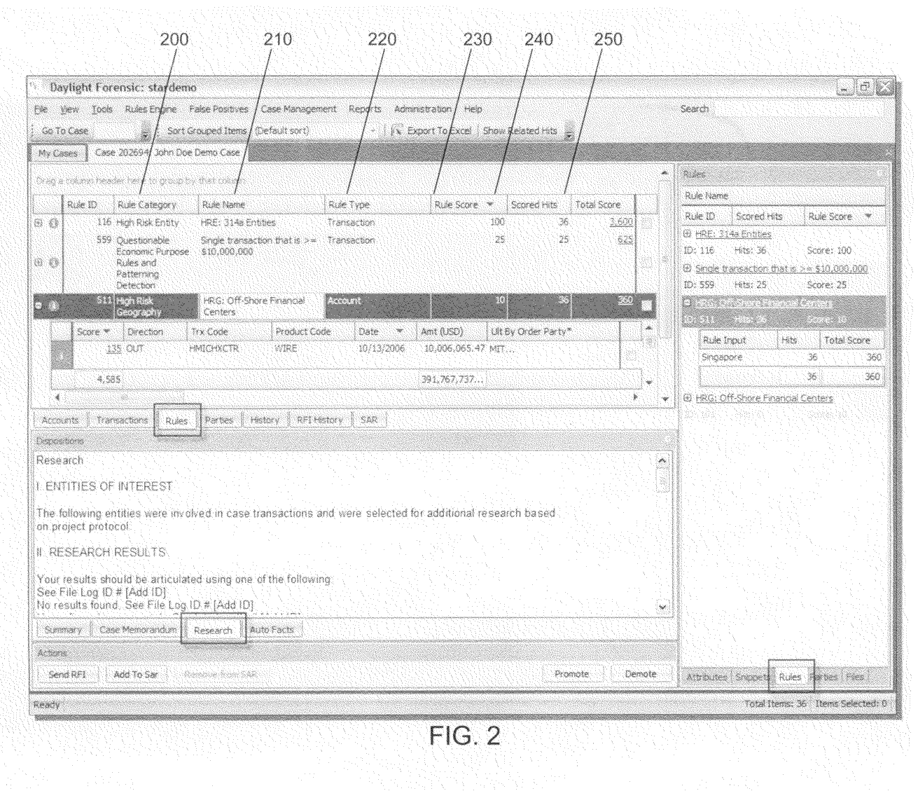

With reference to FIG. 2, an automated alert may be generated for any transaction record that hits against one or more rules. The alert may be provided by identifying the rule category 200, rule name 210, rule type 220, rule score 230 scored hits 240 and total score 250. The rule category 200 identifies which of the rules has received a “hit”. The rule categories are specific to the activity being examined. For example, if FCPA is the activity of concern, rules are established that help identify when compliance with FCPA may be deficient.

The rule categories can be established based on a requirement of a particular statute, or based on the risk attributes 130. For example, with respect to FCPA compliance, the rules may implicate attributes of FCPA violations. The rule categories may include, high risk geography, high risk entity, high risk industry, attempt to conceal, questionable economic purchase, deviation from average account activity, potential nested correspondents, and potential foreign shell companies. For anti-money laundering, the list may include the same rule categories listed above, but may also include others including attempt to conceal identity, attempt to conceal location, high risk vendor, high risk payment terms, and suspicious creation.

The rule name 210 is a descriptive identifier of the rule which is being analyzed. For example the rule category 200 of high risk geography may include several different rules include Eastern Europe and Central Asia, European Union Sanctioned Geographies, off-shore financial centers, etc.

Rule type 220 identifies how the rules are applied. For example a vendor entity typically is analyzed using two types of rules account rules and transactional rules. The account rules search for high risk attributes within basic vendor information relating to the address of the vendor, payment terms, type of industry, etc. Transactional rules search for high risk activity relating to actual payments to the vendor such as round dollar figures, payments below a certain threshold, etc. Other rule types may include ledger rules to look for accounting irregularities or structuring of payments, and vendor rules relating to identifying the vendor, their financial institutions and any intermediaries that may be used.

One problem encountered in the prior art is determining the geographic regions involved in a transaction. Transaction data may include strings of unstructured text that make it difficulty to identify addresses, cities, country codes, etc. The present disclosure uses a country scrubbing algorithm to help identify the geographic regions involved with a transaction. In one embodiment a series of rules can be developed that can be used to analyze the data and a score assigned to each rule so that the proper geographic regions can be located. For example, data appearing on the right side of the text string may be weighted more heavily as a country indication, and data appearing in the begging of the string may be weighted more heavily as a street address. In another embodiment, the unstructured text string may be parsed logically into tokens. Each token can be matched with a database of geographic data containing country codes, city codes, zip codes, country and city names, misspellings of geographic names, etc. For each match a scoring model can be used to increment the score with the highest aggregate score indicating the geographic region. If a city name appears to be identified, but the city is located in the U.S. as well as five other countries, identification of a corresponding zip code in the unstructured text will cause the aggregate score of the U.S. city to exceed the foreign cities. Thus a series of rules can be use to parse the unstructured text string associated with transaction data that was not previously available in the prior art.

The rules engine 120 performs a risking scoring and ranking of each of the analyzed transaction. For example, the rule engine determines a score associated with each rule 240, as well as the aggregate score of each transaction, or entity reviewed 250. Each rule is assigned a score as a function of the importance of the rule in the specific analysis being performed. The score has the effect of weighting the rules with respect to other rules. The score is selectable and thus the weighting of a rule can be changed as desired. For instance if historical analysis shows that a country has had a recent surge in open FCPA investigations, the score of the high risk geography associated with the geographic area can be increased effectively increasing the weighting of the rule.

The transactions or entities with the highest aggregate score 250 can be ranked in order of significance and be flagged for further analysis. For example, the more often a third party activates a high-risk attribute, U.S. or international sanctions of watch lists, the higher its aggregate score becomes. This allows compliance resources to be directed towards potentially high risk relationships and activities. As another example, a vendor located in high-risk geography like Nigeria whose CEO is a former ranking government official and whose payment information asks that payment be sent to a financial institution in Mauritius would earn a high aggregate score. The higher the aggregate score, the higher the risk associated with that particular vendor, thereby creating a bribery risk dashboard to prioritize limited compliance, training and investigative resources.

One problem in prior art systems is the generation of false positives or alerts for transactions or entities that should not otherwise be identified as requiring further analysis. False positives can distract resources from transactions which actually require further analysis. In one embodiment of the present disclosure, each transaction is checked with the rule engine to determine an aggregate score of all rules that were impacted by the transaction. An alert is issued if the aggregate score exceeds some threshold. In order to reduce the false positives the threshold can be set based on historical analysis to provide a more accurate measure for suspicious activity. For example, an analysis of similarly situated transactions may provide an average value and the threshold can be set at some standard deviation from the average value. In another embodiment, the threshold may be set based on a historical analysis of all the transactions of a party. In another embodiment, the threshold can be determined as a function of a historical analysis of the account. In yet another embodiment the threshold can be set as a function of the historical analysis of the rules.

In another embodiment, the rules engine may also avoid the generation of a false positive by using a processing called flattening. For example, each transaction is reviewed against a set of rules. The transaction is scored for each rule that is satisfied, each rule having a different weighting from 5-100 pts. If a single suspicious name shows up in a single transaction multiple rules may hit the transaction due to the single suspicious name and thus cause the scored to be exaggerated. The rules engine is able to identify that the cause of the multiple hits is the single suspicious name and can be programmed to keep the score of the highest hitting rule and weight the score of the other rules that hit to zero to flatten the exaggerated score Likewise if the account of a person on a watch list is being evaluated, and the score for a person on a watch list is 50 points, each evaluation of a rule will be scored at least 50 points since the transaction is occurring in the account of a person on a watch list. However the rules engine can be programmed to recognize the 50 point score as an “inherited score” based on the identity of the account, and separate that score from the transaction score which is determined on its own merits by review against the rules, i.e., the “native score”. Thus the rules engine has the capability to separate native scores from the inherited scores from related rules and thus minimize the amount of false positives that would other wise be created.

Thus, the risk-ranking of the rules engine in the present disclosure has the ability to identify related rules that may hit a transaction and prevent the double counting that would otherwise cause an exaggerated aggregate score to exceed a threshold and create a false positive.

Another problem with prior art case management systems is that a review can result in tens of thousands of alerts. A significant burden exists in grouping of the transactions into cases for further analysis. Improper grouping of case may result in activity that would otherwise be deemed suspicious to go unnoticed. In one embodiment, the rules engine utilizes a casing algorithm to automatically group the transaction in cases to facilitate the further analysis of the transactions. For example, the cases can be grouped according to rule or by party of interest. Grouping by party of interest has been a particularly challenging task in the past. The originator or beneficiary of a transaction may not be readily apparent from the transaction details. The rules engine uses the casing algorithm to correctly match originators and beneficiaries. The casing algorithm uses fuzzy matching technology which takes into account a variety of naming considerations, including abbreviations, foreign transliteration, nicknames, titles, Anglicized words, missing double letters, run together names, typographical errors, extra words, misspellings, single initials and word order. Casing technology is designed to efficiently review the data and minimize investigative searches by collapsing parties into fewer cases rather than reviewing one-off transactions.

In one embodiment of the casing technology that can be utilized in the present disclosure, transaction data is searched to identify the ultimate originator and beneficiary of a transaction. A series of rules can be used to analyze the data to help determine the ultimate originator and beneficiary. For example, in a wire transfer transaction, quite a few fields may be populated with party information. One rule may be that the first named party is scored more heavily than other parties (presuming the first name party is the originator). Another rule may reduce the score if the first named party is a bank (presuming that a bank is not the ultimate originator). The series of rules can be developed based on past patterns and practices and can be specific to the ultimate parties, the financial institutions involved, the type of transaction, etc. A similar set of rules can be used to determine the ultimate beneficiary. Once the ultimate originator and beneficiary are identified, the transaction can be grouped as a function of the ultimate originator, ultimate beneficiary or both. Identifying and grouping cases based on the ultimate parties involved in the transaction is one of the more useful methods of grouping cases but has been largely overlooked in the past due to the complexity of identifying the ultimate parties from the data traditionally provided for transactions.

Case grouping is provided to an analyst who then can review the cases on a user interface 145. The cases can be categorized and protocols can be established for the various categories of cases to establish standardization of review. The user interface 145 allows transactions to be removed, or can allow the addition of un-alerted transactions.

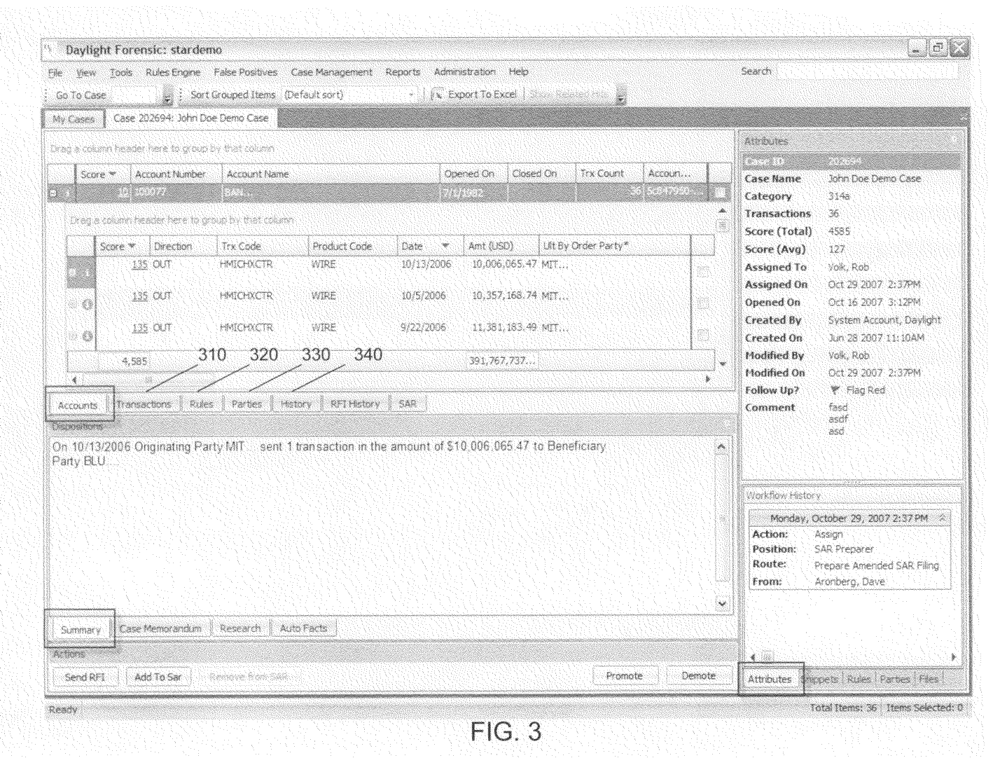

With reference to FIG. 3 a user interface allows a user to view the accounts 300, transactions 310, rules 320 and parties 330. The data on each tab can be expanded to see the transactions relevant to the object. The case attributes are displayed on the right as well as the summarized history 340. The user can document his/her dispositions on the case at the bottom of the screen 350. The analyst may promote the case, request additional information from the bank, add or remove transactions from the SAR filing, and promote or demote the case in a well-defined workflow.

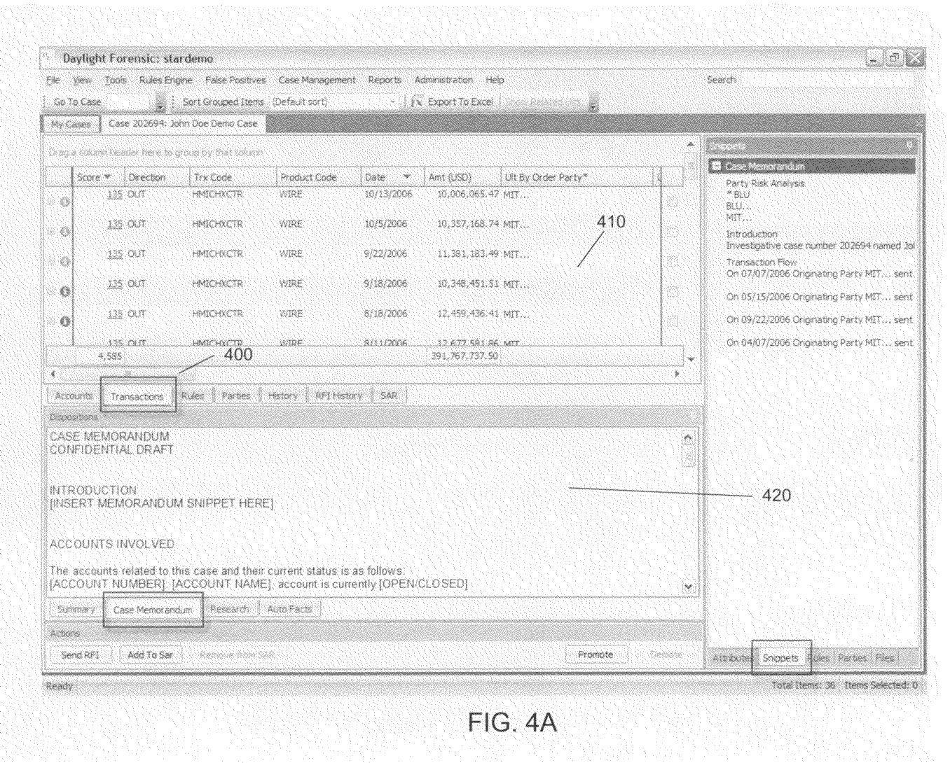

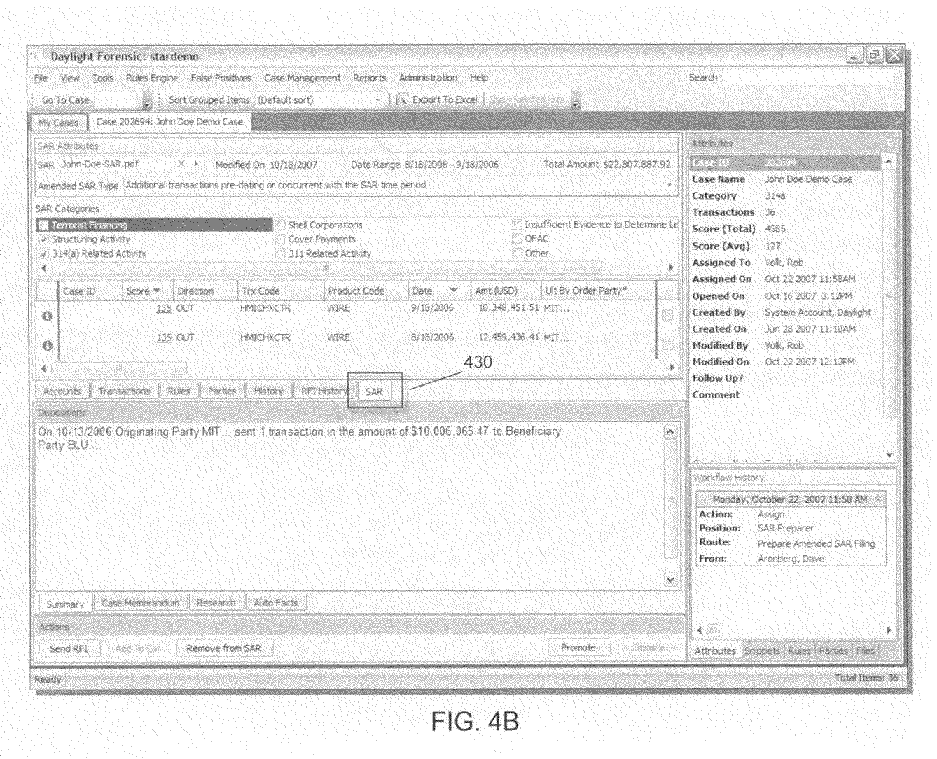

With reference to FIG. 4A, selection of the “Transaction” tab 400 allows the transactions contained in the case to be displayed as well as any related transactions 410. In one embodiment, customized snippets corresponding to each rule are stored to automatically translate the details of a transaction to a textual description of the transaction. Snippets are dynamically-generated lines of text that the analyst may use to convert the transaction details to writing. The use of snippets results in saving time in processing the results and importantly provides standard language so that all written dispositions can be evaluated relative to one another across different analysts.

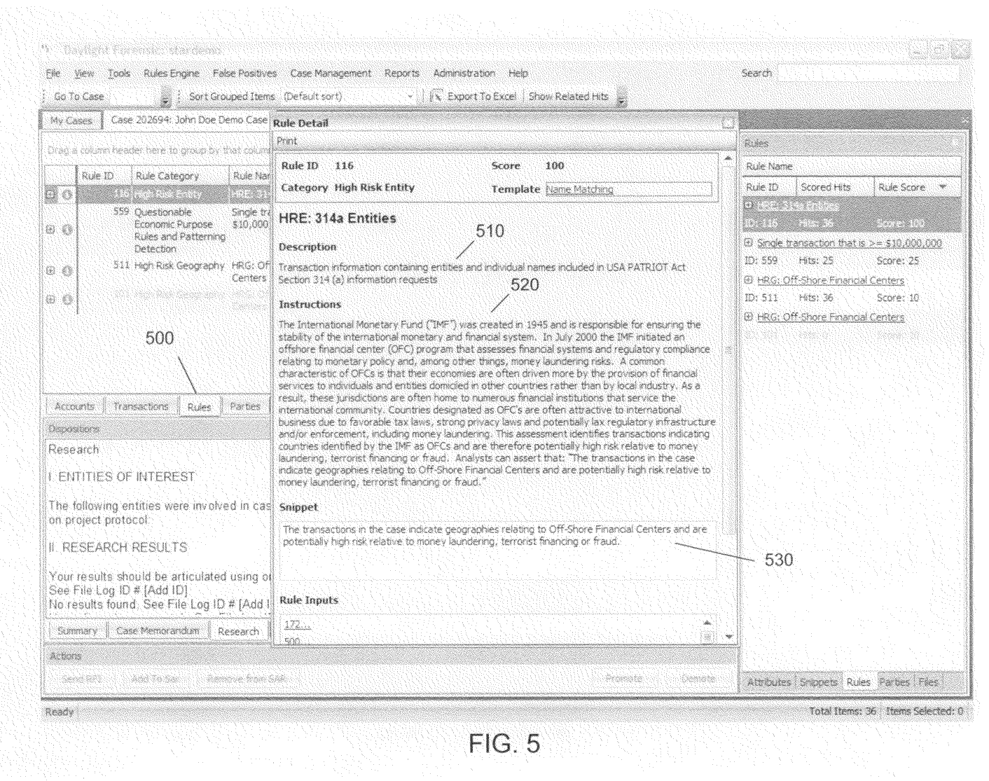

With reference to FIG. 5, when the “Rules” tab 500 is selected, detailed information of a rule is displayed 510 and includes instructions 520 for the analyst when reviewing transactions hit by the rule. The snippet 530 for the rule is also displayed, which the analyst can use as standard language for transactions hit by the rule. The user interface also lists all rule inputs that the rule uses. The snippets may be used to describe a single transaction on the transaction tab, or may be use to describe all transactions in a case.

The snippets provide for the automatic transaction of transaction details to a text string which allows the analyst to quickly compile results and provide a customized report directly from the reviewed case 150. With reference to FIG. 4A, the analyst can create a case memorandum real-time and automatically using snippets 420. The automatic feature of this disclosure allows the analyst to spend more time analyzing and less time on the administrative tasks that are necessary following review. Likewise, customized reports can be generated directly from the reviewed data that satisfy mandated filing requirements. With respect to FIG. 4B the analyst can tag transactions to include in a Suspicious Activity Report (SAR) 430. The transaction will automatically be translated to a text string that is suitable for inclusion in the SAR. Thus, the present disclosure can automatically generate customized reports that can then be electronically filed during the course of the case management. While the automatic nature of this report generation presents a distinct advantage over the prior art, a further benefit is that the snippet provides for a standardization of the customized reports even though they may be generated by many different analysts. Thus, the evaluation of one case relative to another is facilitated since a standardized reporting scheme is used.

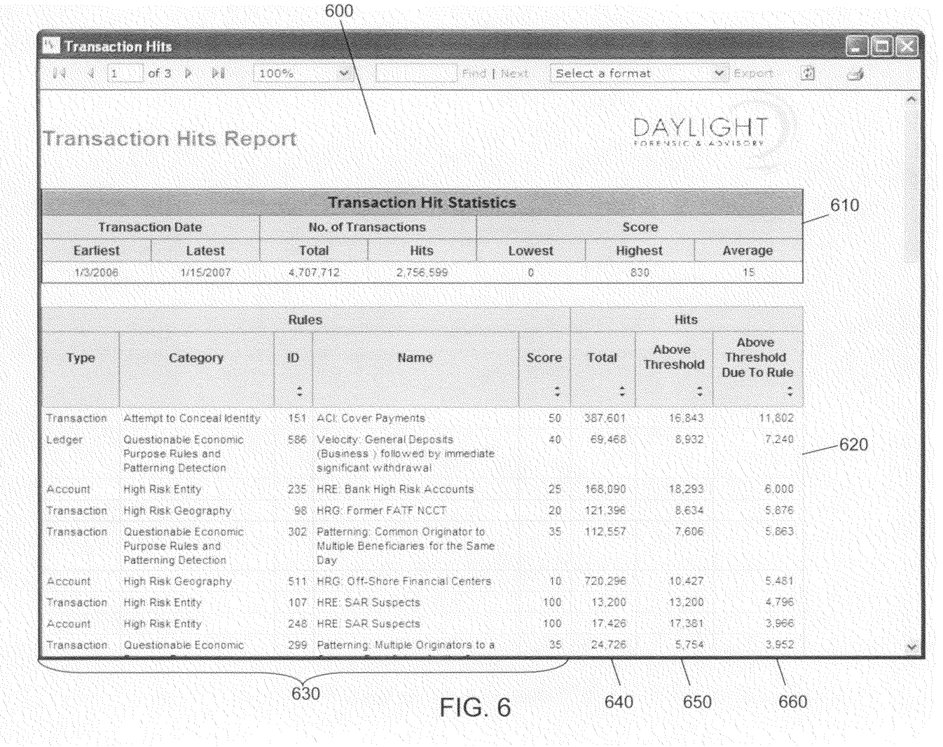

With reference to FIG. 6, the user interface can provide a transaction hit list for use in determining the threshold discussed previously. The “Transaction Hits” report 600 shows the impact that each rule is having in terms of the number of transactions the rule may push over the scoring threshold. It also displays general hit count data. This report may be used extensively during the rule tuning that takes place early in the project lifecycle. The top section contains a summary of the hit population 610. The bottom section provides rule level detail 620. The first five columns fall under the “Rules” heading and contain basic information on the rule 630. The last three columns fall under the “Hits” heading. “Total” 640 is the total number of scoring hits for the rule. “Above Threshold” 650 is the total number of transactions that contain a scoring hit for this rule that are over the scoring threshold. “Above Threshold due to Rule 660” is the total number of transactions that are above the scoring threshold but that would fall below the scoring threshold if the rule were to be removed.

The use of the “Transaction Hits” report allows the user to explore what-if scenarios and thus facilitates fining tuning of the possible thresholds which was not achievable with prior art systems.

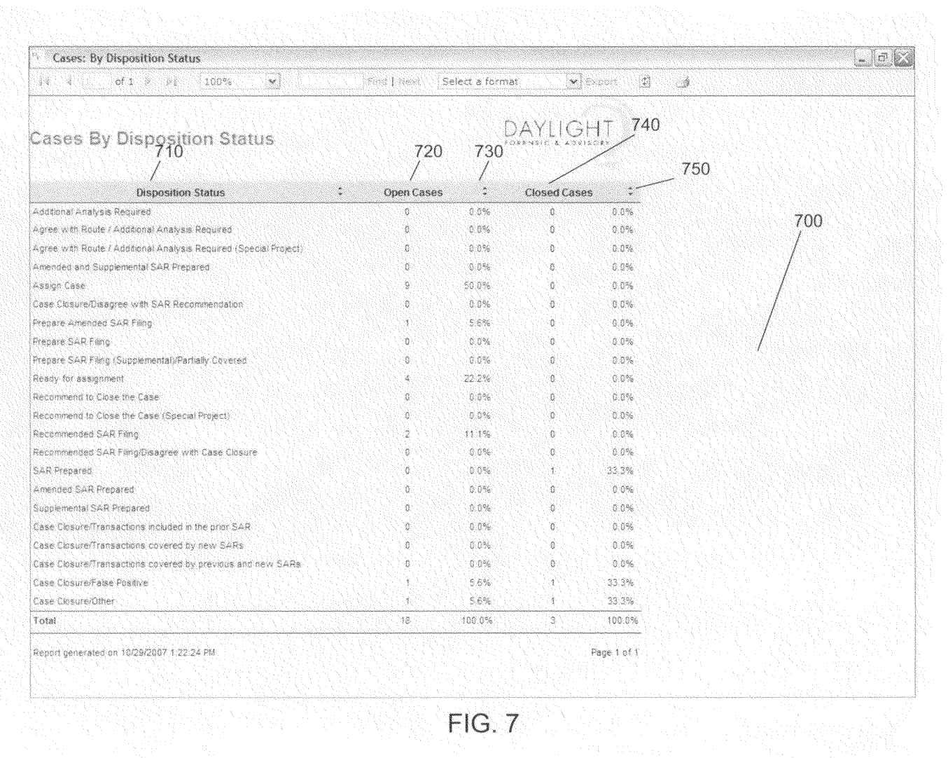

The present disclosure is a workflow based system as the processing flows through many intermediate steps as a case is advanced until ultimately the case is filed or closed. The rules engine maintains track of the cases and can provide customized reports which can used to track the work flow. This is an important aspect of the present disclosure as the reports can be used to provide an audit trail which may be necessary for compliance purposes. FIG. 7 illustrates once such report. This report displays 700 the counts of cases that are in each stage of the workflow. There are five columns. The first displays the name of the workflow position 710. The second column displays the count of Open cases in the position 720. The third column displays the percentage of all the open cases that are in that position 730. The fourth column displays the count of cases that were closed with a given status 740. The fifth column displays the percentage of all closed cases that are in the workflow position 750.

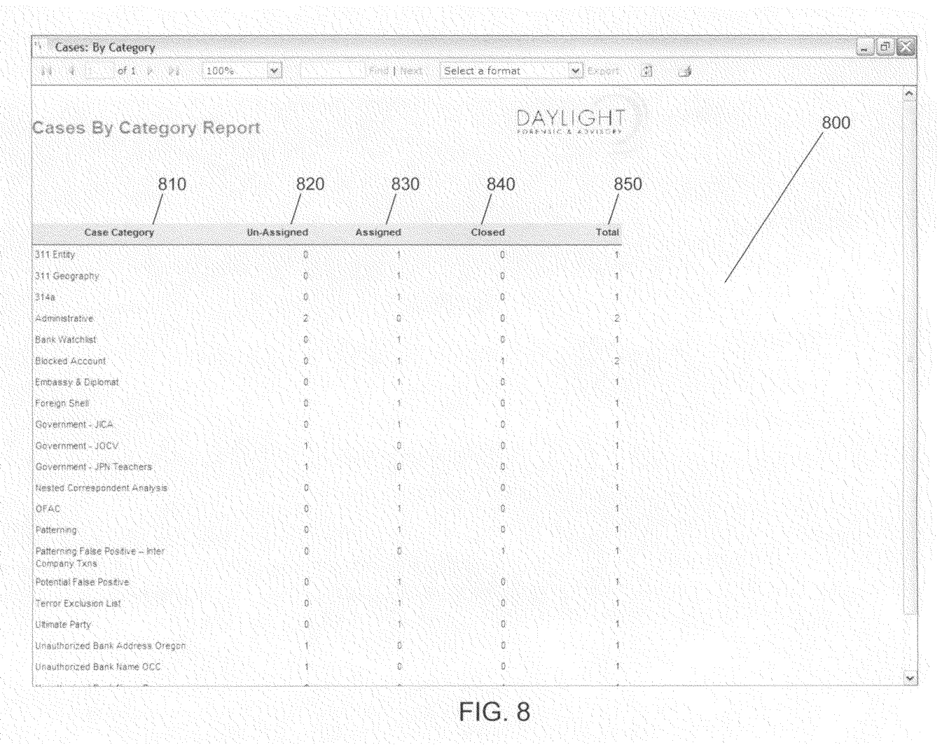

Cases may be put into high level groups know as case categories. Categories are generally indicative of the type of targeted activity being investigated. With Reference to FIG. 8, a report can be generated that displays the counts of cases that are in each category 800. There are five columns. The first displays the name of the category 810. The second column displays the count of Open cases in the category 820. The third column displays the percentage of all the open cases that are in that category 830. The fourth column displays the count of cases that were closed with a given category 840. The fifth column displays the percentage of all closed cases that are in the category. 850

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter affecting a machine-readable propagated signal, or a combination of one or more of them.

The term “rules engine” encompasses all apparatus, devices, and machines for processing data, including by way of example a programmable processor, a computer, or multiple processors or computers. The rules engine can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although a few embodiments have been described in detail above, other modifications are possible. Other embodiments may be within the scope of the following claims.

What is claimed:

1. A method of reviewing a series of transaction to identify suspicious transactions comprising the steps of:
a. receiving transaction data and storing in a database;
b. maintaining a database of rules;
c. assigning a score to each rule;
d. evaluating a stored transaction against a plurality of rules;
e. assigning the score associated with a rule to a transaction for a rule that is satisfied by the transaction;
f. aggregating the score for the transaction;
g. repeating steps d-f for a plurality of transactions;
h. evaluating each aggregated score against a predetermined threshold;
i. issuing an alert for a transaction if its associated aggregated score exceeds the predetermined threshold;
j. displaying the alerted transaction on a user interface;
k. selectively providing a textual string translation for each alerted transaction.

2. The method of claim 1 wherein the transaction data is for a financial transaction.

3. The method of claim 2 wherein the rule includes indicia of a suspicious transaction.

4. The method of claim 3 where the indicia includes at least one of hidden relationships, unusual payment patterns, request for unusual payment terms, shell corporations, missing data, known high-risk geographies, and known high-risk industries.

5. The method of claim 1 further comprising the step of providing a textual string for each rule stored in the database and using a textual string to provide the selected translation

6. The method of claim 1 further comprising the step of generating a report comprising at least one of the selectively provided textual string translations.

7. The method of claim 1 further comprising the steps of
evaluating each rule that is satisfied by a transaction;
determining the relatedness of each evaluated rule; and
reducing the aggregated score for a transaction for each rule that is related.

8. The method of claim 1 wherein the step of evaluating a stored transaction includes the steps of:
(i) parsing the transaction data into a plurality of tokens;
(ii) compare each token to prestored data related to a geographic location;
(iii) assign a score for each token that matches with prestored data;
(iv) for each token, aggregated the score for each match; and
(v) determined the geographic location associated with a transaction as a function of the aggregated score.

9. The method of claim 8 wherein the geographic data includes at least one of country name, country code, state name, state code, city name, city code, country abbreviation, state abbreviation, city abbreviation, and typical misspellings of each thereof.

10. The method of claim 1 wherein the transaction data is financial information including at least one of a wire transfer, a deposit, a withdrawal, a receiving party, and a transferring party.

11. A computerized system for reviewing transaction to identify suspicious transactions comprising:
at least one data input port for receiving:
(a) transaction data for a plurality of transactions; and
(b) a plurality of rules, each rule pertaining to an attribute of a suspicious transaction;
a memory communicating with said at least one data input port (i) for storing as a stored data record each transaction data, and (ii) for storing said plurality of rules;
a processor communicating with said memory and which is programmed to:
(i) evaluate a transaction against the plurality of rules; and
(ii) assign a score for each transaction upon successfully satisfying a rule;
(iii) aggregate a score for each transaction;
(iv) compare each aggregated score against a predetermined threshold;
(v) issue an alert for each transaction associated with an aggregated score that exceeds the predetermined threshold; and
a user interface for displaying the alerted transactions.

12. The system of claim 11 wherein each of the plurality of rules has a selectable score associated with it.

13. The system of claim 12 wherein said user interface accesses said memory to selectably change the selectable score associate with a rule.

14. The system of claim 11 wherein the attribute includes at least one of hidden relationships, unusual payment patterns, request for unusual payment terms, shell corporations, missing data, known high-risk geographies, and known high-risk industries.

15. The system of claim 11 wherein the processor is further programmed to:
(i) evaluate each rule that is satisfied by a transaction;
(ii) determine the relatedness of each evaluated rule; and
(iii) reduce the aggregated score for a transaction for each rule that is related.
